(19) United States
(12) Patent Application Publication
(10) Pub. No.: US 2017/0206786 A1
(43) Pub. Date: Jul. 20, 2017

(54) PARKING SPACE MANAGEMENT USING VIRTUAL PARKING SPACES

(71) Applicant: INTERNATIONAL BUSINESS MACHINES CORPORATION, ARMONK, NY (US)

(72) Inventors: AMOL A. DHONDSE, PUNE (IN); ANAND PIKLE, PUNE (IN); LAURA I. RUSU, VICTORIA (AU); GANDHI SIVAKUMAR, VICTORIA (AU)

(21) Appl. No.: 15/001,463

(22) Filed: Jan. 20, 2016

(51) Int. Cl. G08G 1/14

(52) U.S. Cl. CPC G08G 1/143

(57) ABSTRACT

Embodiments include method, systems and computer program products for management of virtual parking spaces. Aspects include determining a demand level for parking in geographic area, identifying one or more virtual parking spaces in the geographic area that can be allocated to meet the demand level and receiving a parking request from a vehicle in the geographic area. In response to receiving the parking request, aspects also include allocating one of the one or more virtual parking spaces to a vehicle based on a characteristic of the vehicle. Aspects further include transmitting identification information of the one of the one or more virtual parking spaces to the vehicle, wherein the identification information includes a location and a dimension of the one of the one or more virtual parking spaces.

### BACKGROUND

The present disclosure relates to parking space management and more specifically, to methods, systems and computer program products for parking space management using virtual parking spaces.

With the exponential rise in number of vehicles in cities and semi-urban areas in both developed and developing nations, parking space has become a much sought-after resource. Accordingly, the management of parking in an efficient manner is important. While current systems for managing parking spaces exist, such systems attempt to manage the supply of a fixed set of parking spaces by adjusting the cost of using the spaces based on demand.

Advances in communications technologies, the Internet of things and mobile devices have made it possible for automobiles to virtually connect to smarter transportation infrastructure. However, present solutions are based on static physical parking space allocations and are not able to dynamically adjust the supply of parking spaces in any given area.

### SUMMARY

In accordance with an embodiment, a method for management of virtual parking spaces is provided. The method includes determining a demand level for parking in geographic area, identifying one or more virtual parking spaces in the geographic area that can be allocated to meet the demand level and receiving a parking request from a vehicle in the geographic area. In response to receiving the parking request, the method also includes allocating one of the one or more virtual parking spaces to a vehicle based on a characteristic of the vehicle. The method further includes transmitting identification information of the one of the one or more virtual parking spaces to the vehicle, wherein the identification information includes a location and a dimension of the one of the one or more virtual parking spaces.

In accordance with another embodiment, a system for management of virtual parking spaces includes a processor in communication with one or more types of memory. The processor is configured to determine a demand level for parking in geographic area, identify one or more virtual parking spaces in the geographic area that can be allocated to meet the demand level and receive a parking request from a vehicle in the geographic area. In response to receiving the parking request, the processor is configured to allocate one of the one or more virtual parking spaces to a vehicle based on a characteristic of the vehicle. The processor is also configured to transmit identification information of the one of the one or more virtual parking spaces to the vehicle, wherein the identification information includes a location and a dimension of the one of the one or more virtual parking spaces.

In accordance with a further embodiment, a computer program product for management of virtual parking spaces includes a non-transitory storage medium readable by a processing circuit and storing instructions for execution by the processing circuit for performing a method. The method includes determining a demand level for parking in geographic area, identifying one or more virtual parking spaces in the geographic area that can be allocated to meet the demand level and receiving a parking request from a vehicle in the geographic area. In response to receiving the parking request, the method also includes allocating one of the one or more virtual parking spaces to a vehicle based on a characteristic of the vehicle. The method further includes transmitting identification information of the one of the one or more virtual parking spaces to the vehicle, wherein the identification information includes a location and a dimension of the one of the one or more virtual parking spaces.

### BRIEF DESCRIPTION OF THE DRAWINGS

The subject matter which is regarded as the invention is particularly pointed out and distinctly claimed in the claims at the conclusion of the specification. The forgoing and other features, and advantages of the invention are apparent from the following detailed description taken in conjunction with the accompanying drawings in which:

FIG. 1 depicts a cloud computing environment according to an embodiment of the present invention;

FIG. 2 depicts abstraction model layers according to an embodiment of the present invention;

FIG. 3 is a block diagram illustrating one example of a processing system for practice of the teachings herein;

FIG. 4 is a block diagram illustrating a parking space management system in accordance with an exemplary embodiment;

FIGS. 5A and 5B are schematic diagrams illustrating the allocation of virtual parking spaces in a geographic area in accordance with an exemplary embodiment; and

FIG. 6 is a flow diagram of a method for management of virtual parking spaces in accordance with an exemplary embodiment.

### DETAILED DESCRIPTION

It is understood in advance that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

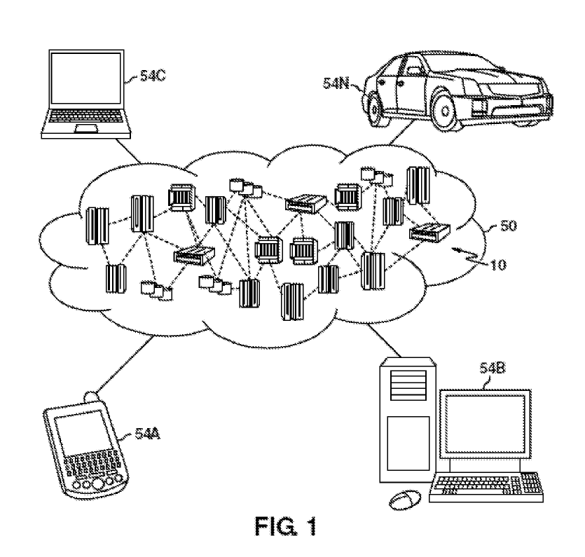

Referring now to FIG. 1, illustrative cloud computing environment 50 is depicted. As shown, cloud computing environment 50 comprises one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 1 are intended to be illustrative only and that computing nodes 10 and cloud computing environment 50 can communicate with any type of computerized device over any type of network and/or network addressable connection (e.g., using a web browser).

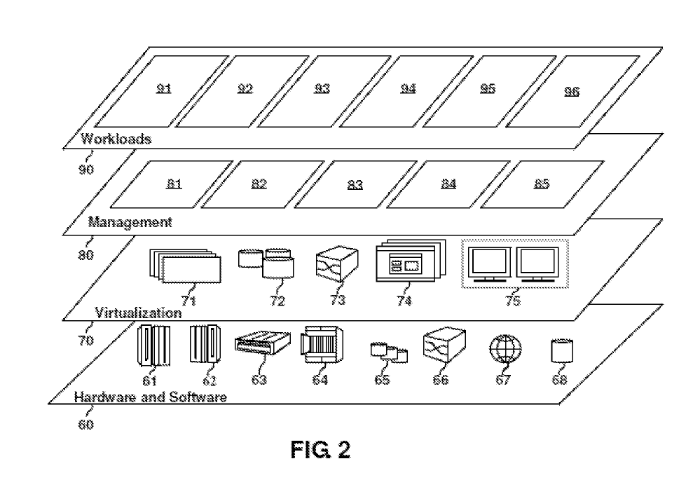

Referring now to FIG. 2, a set of functional abstraction layers provided by cloud computing environment 50 (FIG. 1) is shown. It should be understood in advance that the components, layers, and functions shown in FIG. 2 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provides pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and parking space management 96.

In accordance with exemplary embodiments of the disclosure, methods, systems and computer program products for managing virtual parking spaces are provided. In exemplary embodiments, a virtual parking space is a parking space that does not have fix boundaries, which allows the configuration of the parking space to be modified based on real-time demand. For example, in a parking lot comprised of virtual parking spaces, the size, location and layout of the parking lot can be modified by adjusting the boundaries of each of the parking spaces. Such re-configurable parking solutions can be used to more efficiently allocate the available parking area to the cars that need it. Some cars may require larger spaces due to the size of the car and in addition autonomous, or self-driving, cars may require less space to maneuver in and out of the parking space than human operated cars.

In exemplary embodiments, a parking space management system for managing virtual parking spaces is configured to use virtual parking demarcation and allocation using data generated by traffic sensors for supply management and allocation of parking. The allocation or a virtual parking space is determined by parking space management system and an identification of the allocated parking space is transmitted to a vehicle. The transmitted information is used to identify and demarcate the allocated parking space and assist drivers and self-driven vehicles for navigation, parking assistance and electronic payment for use of the space.

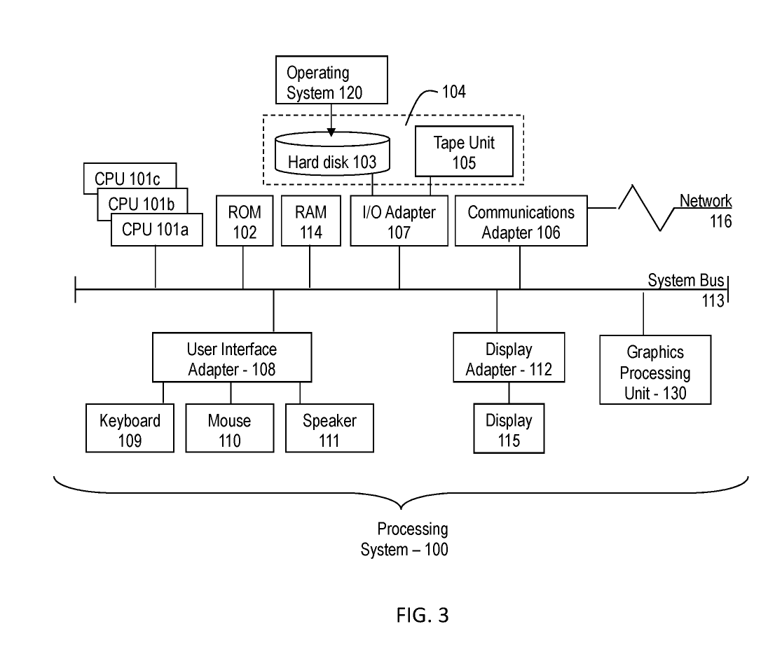

Referring to FIG. 3, there is shown an embodiment of a processing system 100 for implementing the teachings herein. In this embodiment, the system 100 has one or more central processing units (processors) 101a, 101b, 101c, etc. (collectively or generically referred to as processor(s) 101). In one embodiment, each processor 101 may include a reduced instruction set computer (RISC) microprocessor. Processors 101 are coupled to system memory 114 and various other components via a system bus 113. Read only memory (ROM) 102 is coupled to the system bus 113 and may include a basic input/output system (BIOS), which controls certain basic functions of system 100.

FIG. 3 further depicts an input/output (I/O) adapter 107 and a network adapter 106 coupled to the system bus 113. I/O adapter 107 may be a small computer system interface (SCSI) adapter that communicates with a hard disk 103 and/or tape storage drive 105 or any other similar component. I/O adapter 107, hard disk 103, and tape storage device 105 are collectively referred to herein as mass storage 104. Operating system 120 for execution on the processing system 100 may be stored in mass storage 104. A network adapter 106 interconnects bus 113 with an outside network 116 enabling data processing system 100 to communicate with other such systems. A screen (e.g., a display monitor) 115 is connected to system bus 113 by display adaptor 112, which may include a graphics adapter to improve the performance of graphics intensive applications and a video controller. In one embodiment, adapters 107, 106, and 112 may be connected to one or more I/O busses that are connected to system bus 113 via an intermediate bus bridge (not shown). Suitable I/O buses for connecting peripheral devices such as hard disk controllers, network adapters, and graphics adapters typically include common protocols, such as the Peripheral Component Interconnect (PCI). Additional input/output devices are shown as connected to system bus 113 via user interface adapter 108 and display adapter 112. A keyboard 109, mouse 110, and speaker 111 all interconnected to bus 113 via user interface adapter 108, which may include, for example, a Super I/O chip integrating multiple device adapters into a single integrated circuit.

In exemplary embodiments, the processing system 100 includes a graphics processing unit 130. Graphics processing unit 130 is a specialized electronic circuit designed to manipulate and alter memory to accelerate the creation of images in a frame buffer intended for output to a display. In general, graphics processing unit 130 is very efficient at manipulating computer graphics and image processing, and has a highly parallel structure that makes it more effective than general-purpose CPUs for algorithms where processing of large blocks of data is done in parallel.

Thus, as configured in FIG. 3, the system 100 includes processing capability in the form of processors 101, storage capability including system memory 114 and mass storage 104, input means such as keyboard 109 and mouse 110, and output capability including speaker 111 and display 115. In one embodiment, a portion of system memory 114 and mass storage 104 collectively store an operating system to coordinate the functions of the various components shown in FIG. 3.

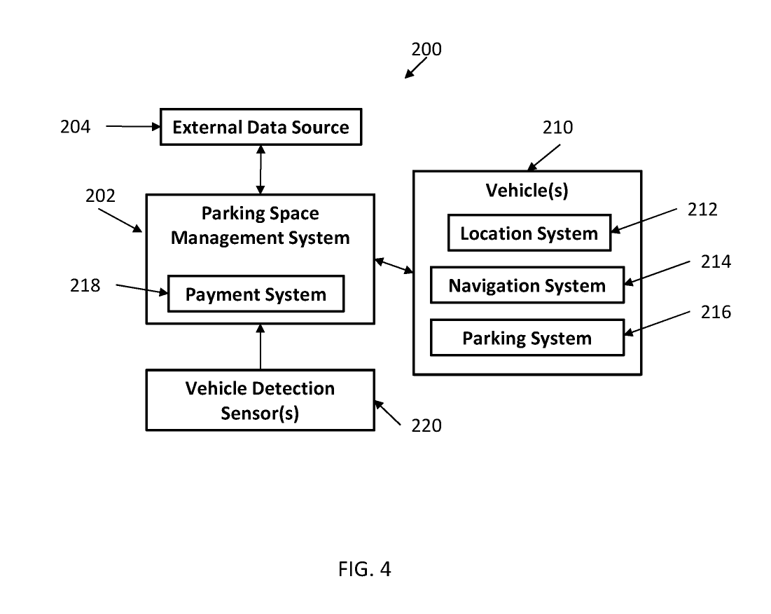

Referring now to FIG. 4, a system 200 for managing virtual parking spaces is illustrated. As illustrated, the system 200 includes a parking space management system 202, one or more vehicles 210, one or more vehicle detection sensors 220 and an external data source 204. In exemplary embodiments, the parking space management system 202 receives a request for an allocation of a parking space from a vehicle 210 and uses information received from the vehicle 210, the vehicle detection sensors 220 and the external data source 204 to allocate a virtual parking space to the vehicle 210. Once the allocation of the virtual parking space has been made, the parking space management system 202 transmits identification information to the vehicle 210, which is used by the vehicle 210 to park in the allocated space. In one embodiment, the vehicle 210 may use the identification information r, as well as 3-D holograph imagery for assisting a user of the vehicle in parking.

In exemplary embodiments, the parking space management system 202 uses the sensors 220 to capture traffic density data, parking usage/availability data. In addition, the parking space management system 202 is configured to access external data sources 204 to obtain other relevant data such as weather or local events (e.g. sporting, festivals, celebrations etc.). In one embodiment, historical parking and traffic data can be used to identify the best predictive factors for parking demand, while real-time data would be used for real-time analysis of the parking demand in the geographical area (e.g. suburb, street, mall etc.).

In exemplary embodiments, the parking space management system 202 is configured to perform run-time supply management using real-time data and predictive forecasting to identify number and location of virtual parking slots that are needed to meet anticipated demand. In addition, the parking space management system 202 is configured to determine virtual parking space allocations based on the characteristics of vehicles that request parking allocations. The characteristics of vehicles can include, but are not limited to, a size and type of a vehicle. In addition, the parking space management system 202 may be configured to determine virtual parking space allocations based on the preferences of users of vehicles that request parking allocations. The preferences of users of vehicles may include, but are not limited to, distance between space and destination, time of day, preferred location, and the like. In one embodiment, the parking space management system 202 may be embodied in a processing system such as the one shown in FIG. 3. In another embodiment, the parking space management system 202 may be part of a cloud computing environment such as the one shown in FIG. 1.

In exemplary embodiments, the parking space management system 202 is also configured to manage allocation and de-allocation of virtual parking spaces. The parking space management system 202 may include a payment system 218 that is configured to charge the vehicles 210 for the use of the virtual parking spaces. In exemplary embodiments, the parking space management system 202 is configured to communicate with the vehicle 210 via any available radio communication channel, such as GSM, CDMA etc.

In exemplary embodiments, the vehicle 210 includes a location system 212, such as a global positioning system, a navigation system 214 and a parking system 216. The navigation system 214 can be used to guide a user of the vehicle 210 to the allocated virtual parking space. The parking system 216 can be used to request a parking space allocation and to facilitate payment for use of the virtual parking spaces. In one embodiment, the navigation system 214 and the parking system 216 can be used to automatically park the vehicle 210 in the allocated parking space.

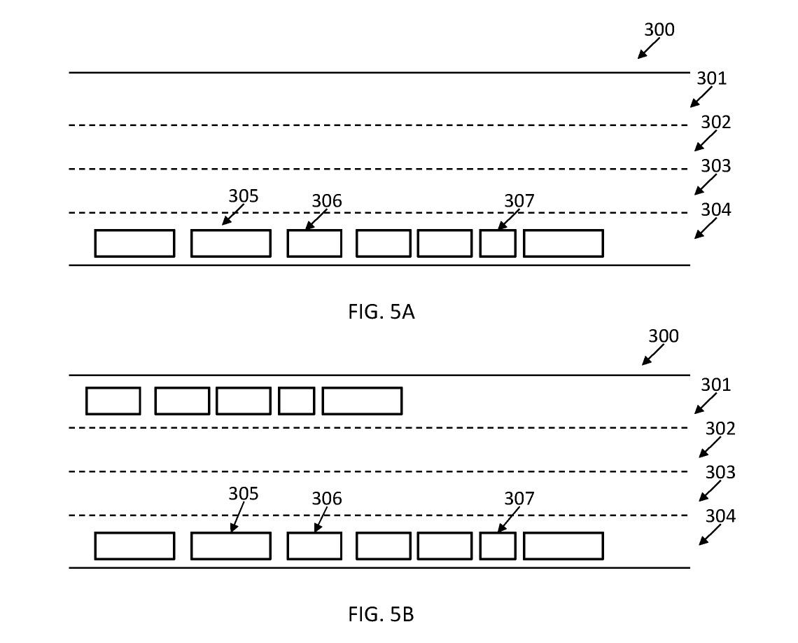

Referring now to FIGS. 5A and 5B a street 300 having a plurality of virtual parking spaces in accordance with an exemplary embodiment are shown. As illustrated, a one way street 300 includes a plurality of lanes 301, 302, 303 and 304. Depending on the demand for parking and on the traffic on the street, a parking space management system may selectively configure one or more lanes 301 and 304 to include virtual parking spaces 305, 306 and 307. As illustrated, the virtual parking spaces 305, 306 and 307 can have different sizes. The size, location and configuration of the virtual parking spaces 305, 306 and 307 in lanes 301 and 304 is determined by the parking space management system to balance the traffic flow on the street 300 and the demand for parking on the street 300. As previously discussed, the virtual parking spaces 305, 306 and 307 do not include visible indications of the locations and/or boundaries of the virtual parking spaces 305, 306 and 307. Accordingly, the size, location and configuration of the virtual parking spaces 305, 306 and 307 in lanes 301 and 304 can be adjusted by the parking space management system. While the parking space management system has been described in managing on-street parking, it will be understood by those of ordinary skill in the art that the parking space management system can also be used to manage an off-street parking lot as well.

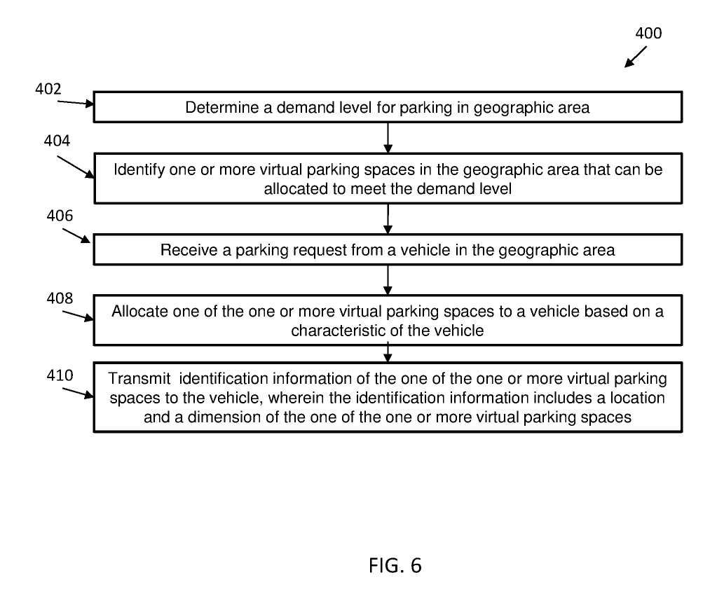

Referring now to FIG. 6, a flow diagram of a method 400 management of virtual parking spaces in accordance with an exemplary embodiment is shown. As shown at block 402, the method 400 includes determining a demand level for parking in geographic area. In exemplary embodiments, the demand level is determined based on one or more of real-time traffic data in the geographic area, a historical demand level for parking in the geographic area, and a forecasted demand level for parking in the geographic area. The forecasted demand level for parking in the geographic area may be based on scheduled events in the geographic area, such as festivals or sporting events. In addition, the forecasted demand level for parking in the geographic area may be.

Next, shown at block 404, the method 400 includes identifying one or more virtual parking spaces in the geographic area that can be allocated to meet the demand level. The method 400 also includes receiving a parking request from a vehicle in the geographic area, as shown at block 406. In exemplary embodiments, the parking request includes the characteristic of the vehicle and may include one or more preferences of a user of the vehicle. Next, shown at block 408, the method 400 in response to receiving the parking request, allocating one of the one or more virtual parking spaces to a vehicle based on a characteristic of the vehicle. In exemplary embodiments, the characteristic of the vehicle includes one or more of a size of a vehicle and a type of a vehicle. In one embodiment, allocating the one of the one or more virtual parking spaces to the vehicle is also based on a preference of a user of the vehicle.

The method 400 also includes transmitting identification information of the one of the one or more virtual parking spaces to the vehicle, wherein the identification information includes a location and a dimension of the one of the one or more virtual parking spaces, as shown at block 406. In exemplary embodiments, the identification information includes data configured to provide visual guidance to a user of the vehicle to the one of the one or more virtual parking spaces. In exemplary embodiments, the method 400 may also include facilitating an electronic payment for use of the one of the one or more virtual parking spaces.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

1. A computer implemented method for management of virtual parking spaces on a street, the computer implemented method comprises:
determining a demand level for parking in a geographic area that includes the street, wherein the demand level is determined based on real-time traffic data in the geographic area, a historical demand level for parking in the geographic area, and a forecasted demand level for parking in the geographic area;
identifying one or more virtual parking spaces in the geographic area that can be allocated to meet the demand level, wherein the one or more virtual parking spaces are disposed in one or more lanes of the street and where the one or more virtual parking spaces do not include visual indicators that demark a boundary;
receiving a parking request from a vehicle in the geographic area;
in response to receiving the parking request, allocating one of the one or more virtual parking spaces to a vehicle based on a characteristic of the vehicle;
transmitting identification information of the one of the one or more virtual parking spaces to the vehicle, wherein the identification information includes a location and a dimension of the one of the one or more virtual parking spaces.

2. (canceled)

3. The computer implemented method of claim 1, wherein the characteristic of the vehicle includes one or more of a size of a vehicle and a type of a vehicle.

4. The computer implemented method of claim 1, wherein allocating the one of the one or more virtual parking spaces to the vehicle is further based on a preference of a user of the vehicle.

5. The computer implemented method of claim 1, where the identification information includes data configured to provide visual guidance to a user of the vehicle to the one of the one or more virtual parking spaces.

6. The computer implemented method of claim 1, further comprising facilitating an electronic payment for use of the one of the one or more virtual parking spaces.

7. (canceled)

8. A computer program product management of virtual parking spaces on a street, the computer program product comprising:
a non-transitory storage medium readable by a processing circuit and storing instructions for execution by the processing circuit for performing a method comprising:
determining a demand level for parking in a geographic area that includes the street, wherein the demand level is determined based on real-time traffic data in the geographic area, a historical demand level for parking in the geographic area, and a forecasted demand level for parking in the geographic area;
identifying one or more virtual parking spaces in the geographic area that can be allocated to meet the demand level, wherein the one or more virtual parking spaces are disposed in one or more lanes of the street and where the one or more virtual parking spaces do not include visual indicators that demark a boundary;
receiving a parking request from a vehicle in the geographic area;
in response to receiving the parking request, allocating one of the one or more virtual parking spaces to a vehicle based on a characteristic of the vehicle;
transmitting identification information of the one of the one or more virtual parking spaces to the vehicle, wherein the identification information includes a location and a dimension of the one of the one or more virtual parking spaces.

9. (canceled)

10. The computer program product of claim 8, wherein the characteristic of the vehicle includes one or more of a size of a vehicle and a type of a vehicle.

11. The computer program product of claim 8, wherein allocating the one of the one or more virtual parking spaces to the vehicle is further based on a preference of a user of the vehicle.

12. The computer program product of claim 8, where the identification information includes data configured to provide visual guidance to a user of the vehicle to the one of the one or more virtual parking spaces.

13. The computer program product of claim 8, further comprising facilitating an electronic payment for use of the one of the one or more virtual parking spaces.

14. (canceled)

15. A system for management of virtual parking spaces on a street, comprising:
a processor in communication with one or more types of memory, the processor configured to:
determine a demand level for parking in a geographic area that includes the street, wherein the demand level is determined based on real-time traffic data in the geographic area, a historical demand level for parking in the geographic area, and a forecasted demand level for parking in the geographic area;
identify one or more virtual parking spaces in the geographic area that can be allocated to meet the demand level, wherein the one or more virtual parking spaces are disposed in one or more lanes of the street and where the one or more virtual parking spaces do not include visual indicators that demark a boundary;
receive a parking request from a vehicle in the geographic area;
in response to receiving the parking request, allocate one of the one or more virtual parking spaces to a vehicle based on a characteristic of the vehicle;
transmit identification information of the one of the one or more virtual parking spaces to the vehicle, wherein the identification information includes a location and a dimension of the one of the one or more virtual parking spaces.

16. (canceled)

17. The system of claim 15, wherein the characteristic of the vehicle includes one or more of a size of a vehicle and a type of a vehicle.

18. The system of claim 15, wherein allocating the one of the one or more virtual parking spaces to the vehicle is further based on a preference of a user of the vehicle.

19. The system of claim 15, where the identification information includes data configured to provide visual guidance to a user of the vehicle to the one of the one or more virtual parking spaces.

20. (canceled)
